(19) United States
(12) Patent Application Publication
(10) Pub. No.: US 2020/0033492 A1
(43) Pub. Date: Jan. 30, 2020

(54) OMNI-DIRECTIONAL GEOPHONE WITH 10 HERTZ NATURAL FREQUENCY

(71) Applicant: GEOSPACE TECHNOLOGIES CORPORATION, Houston, TX (US)

(72) Inventor: Daniel M. WOO, Missouri City, TX (US)

(21) Appl. No.: 16/047,061

(22) Filed: Jul. 27, 2018

(51) Int. Cl. G01V 1/18

(52) U.S. Cl. CPC G01V 1/182; G01V 1/185; G01V 1/184

(57) ABSTRACT

A geophone includes a magnet, an electrical coil assembly, and a tubular case. The electrical coil assembly is disposed about the magnet, and is movable in an axial direction with respect to the magnet. The electrical coil assembly includes a coil, a first spring disposed at a first end of the electrical coil assembly, and a second spring disposed at a second end of the electrical coil assembly. The first spring and the second spring are configured to produce a natural frequency of 9 Hertz to 12.5 Hertz in oscillation of the coil about the magnet. The magnet and the coil assembly are coaxially disposed within the tubular case. The tubular case is no more than 1.7 inches in length. The electrical coil assembly is configured to move in an axial direction with respect to the magnet in any orientation of the tubular case.

### BACKGROUND

A geophone is an instrument that transforms seismic energy into an electrical voltage by responding to the velocity of a seismic wave. Geophones sense motion by suspending an inertial reference mass structure from a rigid, fixed, supporting structure. Typically, the mass is an annular coil suspended by springs in an annulus between a magnet assembly and the housing of the geophone. Usually, one spring is attached at each end of the coil. The springs position the coil within the magnetic field of the magnet assembly so that the coil is centered laterally and along the axis of the magnetic field. The springs also form a suspension system having a predetermined resonant frequency.

In seismic operations, seismic waves are imparted into the earth's crust at or near the earth's surface and portions of those seismic waves are reflected or refracted from the boundaries of subsurface layers. Geophones are disposed on the earth's surface to detect the seismic waves. When reflected or refracted waves encounter a geophone, the coil, which is suspended between the two springs, tends to remain still while the geophone housing and its connected magnet assembly moves with the earth's surface. The movement of the coil through the magnetic field of the magnet assembly generates a voltage at the output of the geophone. The outputs of the geophones are recorded in a form that permits analysis, Skilled interpreters can discern from the analysis the shape of subsurface formations and the likelihood of finding an accumulation of hydrocarbons, such as oil or gas.

### SUMMARY

Miniaturized omni-directional geophones with a 10 Hertz natural frequency are disclosed herein. In some embodiments, a geophone includes a magnet, a first pole cap, an electrical coil assembly, and a tubular case. The first pole cap is disposed at and engages a first end of the magnet. The first pole cap includes a first end and a shoulder that is parallel to and spaced apart from the first end of the first pole cap by at least 0.1 inches. The electrical coil assembly is disposed about the magnet and the first pole cap. The electrical coil assembly is movable in an axial direction with respect to the magnet and the first pole cap. The electrical coil assembly includes a first coil form, and a first spring disposed between a first end of the first coil form and the first end of the first pole cap. The first spring is disposed parallel to and is spaced apart from the shoulder of the first pole cap by at least 0.1 inches. The magnet, the first pole cap, and the coil assembly are coaxially disposed within the tubular case. The tubular case is no more than 1.7 inches in length.

In other embodiments, a geophone includes a magnet, an electrical coil assembly, and a tubular case. The electrical coil assembly is disposed about the magnet. The electrical coil assembly is movable in an axial direction with respect to the magnet. The electrical coil assembly includes a coil, a first spring, and a second spring. The first spring is disposed at a first end of the electrical coil assembly. The second spring is disposed at a second end of the electrical coil assembly. The first spring and the second spring are configured to produce a natural frequency of 9 Hertz to 12.5 Hertz in oscillation of the coil with respect to the magnet. The magnet and the coil assembly are coaxially disposed within the tubular case. The tubular case is no more than 1.7 inches in length. The electrical coil assembly is configured to move in an axial direction with respect to the magnet in any orientation of the tubular case.

In further embodiments, a geophone includes a tubular case, a magnet, a first pole cap, a second pole cap, and an electrical coil assembly. The tubular case is no more than 1.7 inches in length and no more than 1.25 inches in diameter. The first pole cap is disposed at and engages a first end of the magnet. The first pole cap includes a first end, and a shoulder that is parallel to and spaced apart from the first end of the first pole cap by at least 0.1 inches. The second pole cap is disposed at and engages a second end of the magnet. The second pole cap includes a first end, and a shoulder that is parallel to and spaced apart from the first end of the second pole cap by at least 0.1 inches. The electrical coil assembly is disposed about the magnet, the first pole cap, and the second pole cap. The electrical coil assembly is movable in an axial direction with respect to the magnet, the first pole cap, and the second pole cap. The electrical coil assembly includes a first coil form, a second coil form, a first spring, and a second spring. The first spring is disposed between a first end of the first coil form and the first end of the first pole cap. The first spring is disposed parallel to and is spaced apart from the shoulder of the first pole cap by at least 0.1 inches. The second spring is disposed between a first end of the second coil form and the first end of the second pole cap. The second spring is disposed parallel to and is spaced apart from the shoulder of the second pole cap by at least 0.1 inches. The first spring and the second spring are configured to produce a natural frequency of 9 Hertz to 12.5 Hertz in oscillation of the electrical coil assembly about the magnet. The magnet, the first pole cap, the second pole cap, and the coil assembly are coaxially disposed within the tubular case, and the electrical coil assembly is configured to move in an axial direction with respect to the magnet in any orientation of the tubular case.

### BRIEF DESCRIPTION OF THE DRAWINGS

For a detailed description of exemplary embodiments, reference will now be made to the accompanying drawings, in which:

FIG. 1 shows an exploded view of a first example of an omni-directional geophone with a 10 Hertz natural frequency in accordance with the present disclosure;

FIG. 2 shows an end view of an example of an omni-directional geophone with a 10 Hertz natural frequency in accordance with the present disclosure;

FIG. 3 shows a cross-sectional view of an example of an omni-directional geophone with a 10 Hertz natural frequency in accordance with the present disclosure;

FIG. 4 shows a cross-sectional view of an example of an omni-directional geophone with a 10 Hertz natural frequency disposed in a first vertical orientation in accordance with the present disclosure;

FIG. 5 shows a cross-sectional view of an example of an omni-directional geophone with a 10 Hertz natural frequency disposed in a second vertical orientation in accordance with the present disclosure; and

FIG. 6 shows a cross-sectional view of a second example of an omni-directional geophone with a 10 Hertz natural frequency in accordance with the present disclosure.

### NOTATION AND NOMENCLATURE

In the following discussion and in the claims, the terms “including” and “comprising” are used in an open-ended fashion, and thus should be interpreted to mean “including, but not limited to . . . ”. The term “couple” is not meant to limit the interaction between elements to direct interaction between the elements and may also include indirect interaction between the elements described. The term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of additional factors.

### DETAILED DESCRIPTION

In the drawings and description of the present disclosure, like parts are typically marked throughout the specification and drawings with the same reference numerals. The drawing figures are not necessarily to scale. Certain features of the invention may be shown exaggerated in scale or in somewhat schematic form, and some details of conventional elements may not be shown in the interest of clarity and conciseness. The present disclosure is susceptible to embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings and components of the embodiments discussed below may be employed separately or in any suitable combination to produce desired results.

Single component seismic data acquisition typically employs geophones that operate properly only when deployed within a limited range of tilt from vertical (e.g., with a limited deviation from the direction of Earth's gravity). In contrast, multi-component seismic data acquisition employs geophones that are deployed at tilt angles that differ substantially from the direction of the Earth's gravity. For example, a three component seismic sensor may include a first geophone intended to be deployed in-line with the direction of the Earth's gravity, a second geophone disposed normal to the first geophone, and a third geophone disposed normal to the first and second geophones. Under some survey conditions (e.g., ocean bottom surveys), the orientations of the geophones, relative to gravity is not controlled. Because geophones designed for vertical deployment operate properly only within a limited range of tilt angles, such geophones may not be suitable for use in multi-component seismic data acquisition or in situations where the orientation of the geophone is uncontrolled. Instead, geophones designed to operate at any angle of tilt (i.e., omni-direction geophones) are employed in situations where the orientation of the geophone may be other that vertical.

To provide optimal sensitivity to the low amplitude signals encountered in seismic data acquisition, the natural frequency of the geophones employed should be at least as low as the lowest frequency of interest being acquired. Because the frequency of interest in a seismic survey may be relatively low (e.g., 10 Hertz or lower), it is desirable for the natural frequency of the geophone used to acquire such frequencies to be equally low. Conventional omni-directional geophones are limited to a natural frequency of about 14 Hertz. The sensitivity of such geophones is reduced by about 12 Decibels per octave below 14 Hertz, which limits the sensitivity of the geophone for acquisition of signals at 10 Hertz and below. Furthermore, in order to reduce the size, weight, and associated cost of deployment, it is desirable that the size of the omni-directional geophones deployed to acquire multi-component seismic data be reduced.

The geophones disclosed herein are omni-directional and include a relatively low natural frequency. For example, embodiments of the omni-directional geophones disclosed herein may have a natural frequency of about 10 Hertz (e.g., a natural frequency in a range of 9.5 Hertz to 12.5 Hertz). Sensitivity of the disclosed geophones may be about 2 volts/inch/second at the 10 Hertz natural frequency. The disclosed geophones are also relatively small in size. Some embodiments may have an outside diameter of 1.15 to 1.25 inches and an outside length of 1.5 to 1.75 inches.

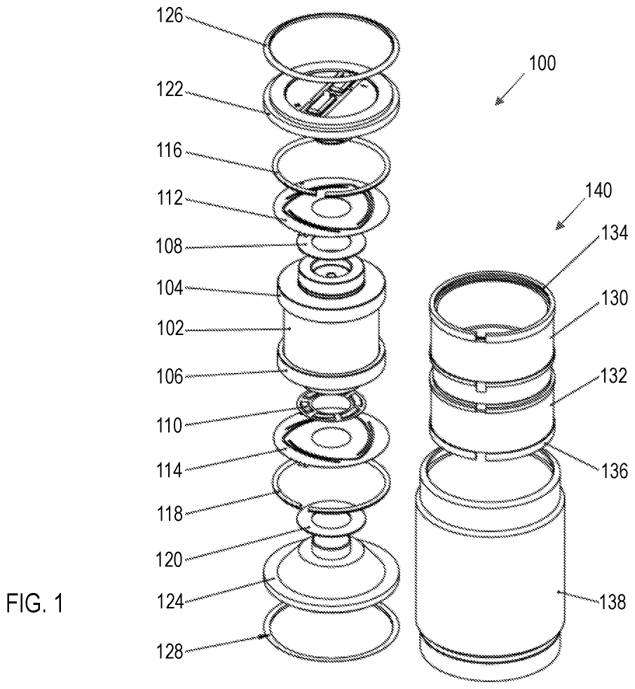

FIG. 1 shows an exploded view of a first example of an omni-directional geophone 100 with a 10 Hertz natural frequency in accordance with the present disclosure. The omni-directional geophone 100 includes a cylindrical magnet 102, a pole cap 104, a pole cap 106, an insulated spacer 108, an insulated spacer 120, a contact for terminal A 110, a spring 112, a spring 114, a retainer ring 116, a retainer ring 118, a header cap 122, a header cap 124, a seal 126, a seal 128, a coil form 134, a coil form 136, a coil 130, a coil 132, and an outer case 138. The cylindrical magnet 102, pole cap 104, pole cap 106, insulated spacer 108, insulated spacer 120, contact for terminal A 110, spring 112, spring 114, retainer ring 116, retainer ring 118, header cap 122, and header cap 124 are axially disposed within the outer case 138. The coil 130, coil 132, coil form 134, and coil form 136 form an electrical coil assembly 140 that is disposed within the outer case 138 about the cylindrical magnet 102, the pole cap 104, and the pole cap 106, and bounded by the spring 112 and the spring 114. The spring 112 and spring 114, which may be of a type referred to as “spider springs,” allow the coil 130, coil 132, coil form 134, and coil form 136 to move longitudinally with respect to the cylindrical magnet 102 within the outer case 138 and may be considered components of the electrical coil assembly 140. The coil 130 includes wire (e.g., magnet wire) that is circumferentially wound about the coil form 134. Similarly, the coil 132 includes wire that is circumferentially wound about the coil form 136. The pole cap 104, the pole cap 106, and the outer case 138 may be made of a ferrous material. The header cap 122 and the header cap 124 may be made of an electrically non-conductive material, such as plastic.

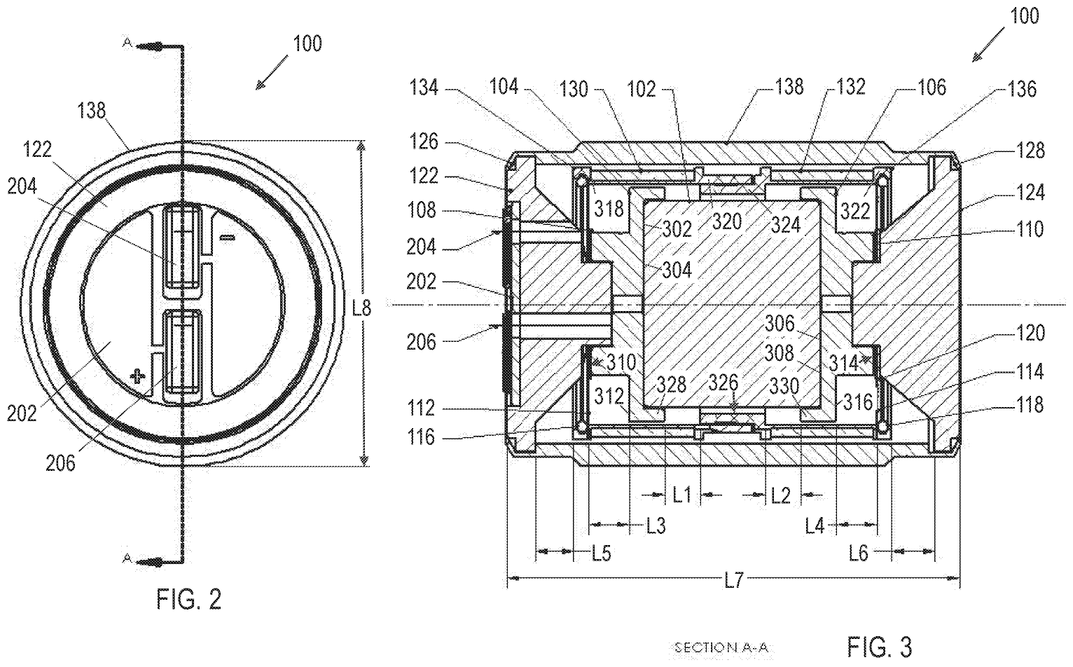

FIG. 2 shows an end view of an example of an omni-directional geophone 100 with a 10 Hertz natural frequency in accordance with the present disclosure. The header cap 122 includes a printed circuit board 202. The printed circuit board 202 includes a positive terminal 206 and a negative terminal 204. The positive terminal 206 and the negative terminal 204 provide access to signals indicative of the motion of the omni-directional geophone 100 (produced by movement of the cylindrical magnet 102 relative to the coil 130 and the coil 132). The positive terminal 206 is connected to the coil 132 via the spring 114, the pole cap 106, the cylindrical magnet 102, and the pole cap 104. The negative terminal 204 is connected to the coil 130 via the spring 116. The outer diameter of the outer case 138 (i.e., the outer diameter of the omni-directional geophone 100) is shown as dimension L8, where L8 is in a range or 1.15 to 1.25 inches.

FIG. 3 shows a cross-sectional view of an example of an omni-directional geophone 100 with a 10 Hertz natural frequency in accordance with the present disclosure. The cross-section of FIG. 3 is along the line A-A shown in FIG. 2 (i.e., diametrically through the omni-directional geophone 100 along a center line of the negative terminal 204 and the positive terminal 206. The cylindrical magnet 102 is centrally disposed within the outer case 138. The pole cap 104 and the pole cap 106 engage and retain opposing ends of the cylindrical magnet 102. The pole cap 104 includes a first end 302 that forms a cap that engages a first end 304 of the cylindrical magnet 102. The first end 302 of the pole cap 104 includes an annular lip 328 that retains the first end 304 of the cylindrical magnet 102. The pole cap 106 may be identical to the pole cap 104, and the first end 306 of the pole cap 106 engages a second end 308 of the cylindrical magnet 102. The first end 306 of the pole cap 106 includes an annular lip 330 that retains the second end 308 of the cylindrical magnet 102.

The pole cap 104 includes a second end 310 that engages the header cap 122. Similarly, the pole cap 106 includes a second end 314 that engages the header cap 124. The header cap 122 and the header cap 124 are retained within the outer case 138 by crimping or swaging the ends of the outer case 138 about the header cap 122 and header cap 124. The seal 126 is disposed between the header cap 122 and the outer case 138 to seal the adjoining faces of the header cap 122 and the outer case 138. Similarly, the seal 128 is disposed between the header cap 124 and the outer case 138 to seal the adjoining faces of the header cap 124 and the outer case 138.

The spring 112 is disposed between the header cap 122 and the second end 310 of the pole cap 104, with the insulated spacer 108 disposed between the spring 112 and the second end 310 of the pole cap 104. The spring 114 is disposed between the header cap 124 and the second end 314 of the pole cap 106 with the contact for terminal A 110 and the insulated spacer 120 disposed between the spring 114 and the second end 314 of the pole cap 106. The spring 112 and the spring 114 allow the cylindrical magnet 102, the pole cap 104, the pole cap 106, and the outer case 138 to move coaxially with respect to the coil 130 and the coil 132, while the coil 130 and the coil 132 are decoupled from the motion of the rest of the omni-directional geophone 100.

The coil form 134 includes a first end 318 that engages the spring 112. Engagement of the coil form 134 and the spring 112 is maintained by the retainer ring 116. Similarly, the coil form 136 includes a first end 322 that engages the spring 114, where engagement of the coil form 136 and the spring 114 is maintained by the retainer ring 118. A second end 320 of the coil form 134 engages a second end 324 of the coil form 136. In some embodiments, the engagement of the second end 320 of the coil form 134 and the second end 324 of the coil form 136 forms an annular ring 326 about the cylindrical magnet 102.

The spring 112 and the spring 114 are designed to allow movement of the coil 130, the coil 132, the coil form 134, and the coil form 136 with respect to the cylindrical magnet 102 with a natural frequency in a range of 9.5 Hertz to 12.5 Hertz. Motion at such low natural frequencies, in any orientation of the omni-directional geophone 100, is facilitated by the spacing and dimensions of the various components of the omni-directional geophone 100. The overall length of the outer case 138 (e.g., the length of the omni-directional geophone 100) is shown as length L7, where L7 is in a range of 1.5 to 1.7 inches. The dimensions L1-L6 discussed below are given under conditions where the annular ring 326 is disposed at a longitudinal center of the cylindrical magnet 102 (i.e., the engaged coil form 134 and coil form 136 are longitudinally centered with respected to the cylindrical magnet 102). The annular lip 328 that retains the cylindrical magnet 102 is spaced apart from the annular ring 326 by a length L1, where L1 is at least 0.1 inches. Similarly, the annular lip 330 that retains the cylindrical magnet 102 is spaced apart from the annular ring 326 by a length L2, where L2 is at least 0.1 inches. The pole cap 104 includes a shoulder 312 that is spaced apart from the second end 310 and the spring 112 by a length L3, where L3 is at least 0.1 inches. Similarly, the pole cap 106 includes a shoulder 316 that spaced apart from the second end 314 and the spring 114 by a length L4, where L4 is at least 0.1 inches. The first end 318 of the coil form 134 is spaced apart from the header cap 122 by a length of L5, where L5 is at least 0.1 inches, and the first end 322 of the coil form 136 is spaced apart from the header cap 124 by a length of L6, where L6 is at least 0.1 inches. The dimensions L1-L6 provide sufficient clearance to enable omni-directional operation of the omni-directional geophone 100 at a natural frequency of about 10 Hertz.

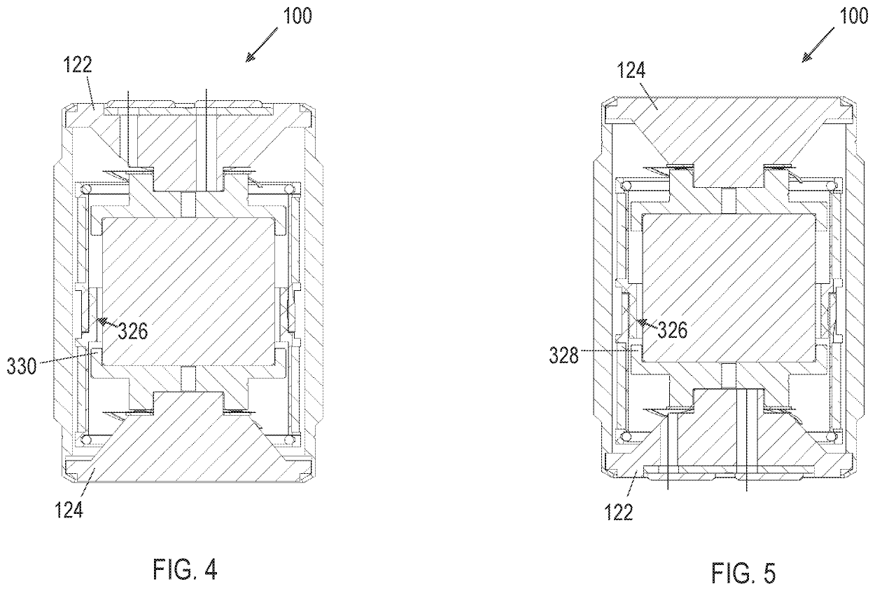

FIG. 4 shows a cross-sectional view of an example of an omni-directional geophone 100 with a 10 Hertz natural frequency disposed in a first vertical orientation in accordance with the present disclosure. In FIG. 4, the omni-directional geophone 100 is disposed vertically with the header cap 122 at the top of the omni-directional geophone 100, and the header cap 124 at the bottom of the omni-directional geophone 100. In FIG. 4, gravity acting on the coil form 134 and the coil form 136 has moved the coil form 134 and the coil form 136 towards the header cap 124. In the orientation of FIG. 4, the dimensions L2, L3, and L6 (each about 0.1 inch) provide clearance for movement of the coil form 134 and the coil form 136 with respect to the cylindrical magnet 102.

FIG. 5 shows a cross-sectional view of an example of an omni-directional geophone 100 with a 10 Hertz natural frequency disposed in a second vertical orientation in accordance with the present disclosure. In FIG. 5, the omni-directional geophone 100 is disposed vertically with the header cap 124 at the top of the omni-directional geophone 100, and the header cap 122 at the bottom of the omni-directional geophone 100. In FIG. 5, gravity acting on the coil form 134 and the coil form 136 has moved the coil form 134 and the coil form 136 towards the header cap 122. In the orientation of FIG. 5, the dimensions L1, L4, and L5 (each about 0.1 inch) provide clearance for movement of the coil form 134 and the coil form 136 with respect to the cylindrical magnet 102.

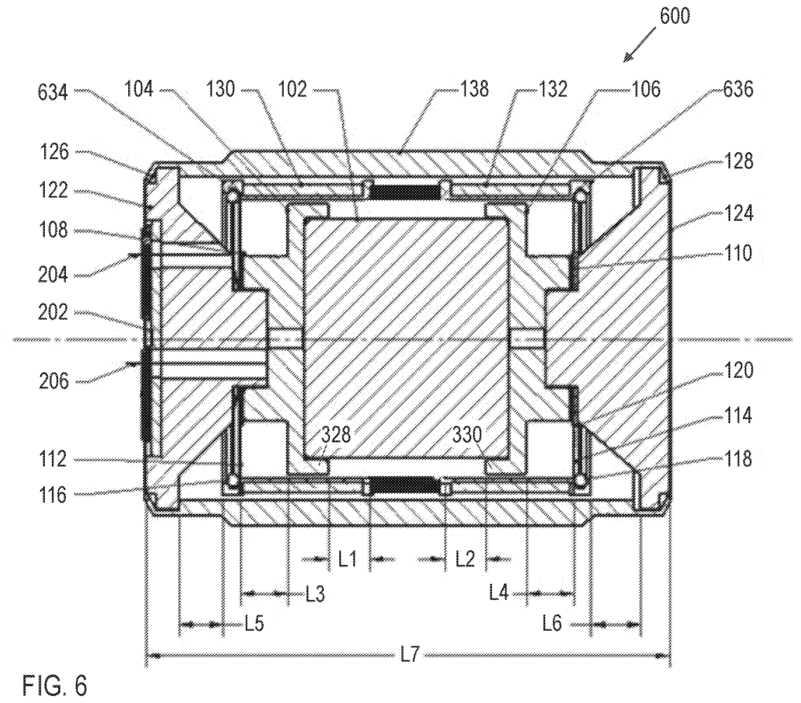

FIG. 6 shows a cross-sectional view of an example of an omni-directional geophone 600 with a 10 Hertz natural frequency in accordance with the present disclosure. The omni-directional geophone 600 is generally similar to and may be considered an embodiment of the omni-directional geophone 100. The omni-directional geophone 600 includes a coil form 634 and a coil form 636. Engagement of the coil form 634 and the coil form 636 does not form an annular ring 326 that may make contact with the annular lip 328 or the annular lip 330. In the omni-directional geophone 600 the coil form 634 may be allowed to contact the header cap 122 and the coil form 636 may be allowed to contact the header cap 124.

The above discussion is meant to be illustrative of various principles and embodiments of the present disclosure. While certain embodiments have been shown and described, modifications thereof can be made by one skilled in the art without departing from the spirit and teachings of the disclosure. The embodiments described herein are exemplary only, and are not limiting. Accordingly, the scope of protection is not limited by the description set out above, but is only limited by the claims which follow, that scope including all equivalents of the subject matter of the claims.

What is claimed is:

1. A geophone, comprising:
a magnet;
a first pole cap disposed at and engaging a first end of the magnet, the first pole cap comprising:
a first end; and
a shoulder that is parallel to and spaced apart from the first end of the first pole cap by at least 0.1 inches;
an electrical coil assembly disposed about the magnet and the first pole cap, wherein the electrical coil assembly is movable in an axial direction with respect to the magnet and the first pole cap, the electrical coil assembly comprising:
a first coil form;
a first spring disposed between a first end of the first coil form and the first end of the first pole cap, wherein the first spring is disposed parallel to and is spaced apart from the shoulder of the first pole cap by at least 0.1 inches; and
a tubular case within which the magnet, the first pole cap, and the coil assembly are coaxially disposed, wherein the tubular case is no more than 1.7 inches in length.

2. The geophone of claim 1, further comprising a second pole cap disposed at and engaging a second end of the magnet, the second pole cap comprising:
a first end; and
a shoulder that is parallel to and spaced apart from the first end of the second pole cap by at least 0.1 inches.

3. The geophone of claim 1, wherein the electrical coil assembly is disposed about the second pole cap, and is movable in an axial direction with respect to the second pole cap, the electrical coil assembly comprising;
a second coil form;
a second spring disposed between a first end of the second coil form and the first end of the second pole cap, wherein the second spring is disposed parallel to and is spaced apart from the shoulder of the second pole cap by at least 0.1 inches.

4. The geophone of claim 3, wherein:
the first coil form comprises a second end, and the second coil form comprises a second end; wherein the second end of the first coil form engages the second end of the second coil form to form an annular ring about the magnet; and
the first pole cap comprises a second end that forms a cap that engages the first end of the magnet, the cap comprising a first annular lip that retains the magnet; and
the annular ring about the magnet is spaced apart from the first annular lip by at least 0.1 inches.

5. The geophone of claim 4, wherein:
the second pole cap comprises a second end that forms a cap that engages the second end of the magnet, the cap comprising a second annular lip that retains the magnet; and
the annular ring about the magnet is spaced apart from the second annular lip by at least 0.1 inches.

6. The geophone of claim 1, wherein first spring is configured to produce a natural frequency of the electrical coil assembly about the magnet of from 9.5 Hertz to 12.5 Hertz.

7. The geophone of claim 1, wherein the electrical coil assembly is configured to move in an axial direction with respect to the magnet in any orientation of the tubular case.

8. The geophone of claim 1, wherein the tubular case has an outside diameter of no more than 1.25 inches.

9. A geophone, comprising:
a magnet;
an electrical coil assembly disposed about the magnet, wherein the electrical coil assembly is movable in an axial direction with respect to the magnet, the electrical coil assembly comprising;
a coil;
a first spring disposed at a first end of the electrical coil assembly;
a second spring disposed at a second end of the electrical coil assembly;
wherein the first spring and the second spring are configured to produce a natural frequency of 9 Hertz to 12.5 Hertz in oscillation of the coil about the magnet;
a tubular case within which the magnet and the coil assembly are coaxially disposed, wherein the tubular case is no more than 1.7 inches in length;
wherein the electrical coil assembly is configured to move in an axial direction with respect to the magnet in any orientation of the tubular case.

10. The geophone of claim 9, further comprising a first pole cap disposed at and engaging a first end of the magnet, the first pole cap comprising:
a first end;
a shoulder that is parallel to and spaced apart from the first end of the first pole cap by at least 0.1 inches;
a second end that forms a cap that engages the first end of the magnet, the cap comprising a first annular lip that retains the magnet.

11. The geophone of claim 10, wherein the first spring is disposed parallel to and is spaced apart from the shoulder of the first pole cap by at least 0.1 inches.

12. The geophone of claim 10, further comprising:
a first coil form comprising:
a first end; and
a second end;
wherein the first spring is disposed at the first end of the first coil form;
a second coil form comprising:
a first end; and
a second end;
wherein the second spring is disposed at the first end of the second coil form;
wherein the second end of the first coil form engages the second end of the second coil form to form an annular ring about the magnet; and the annular ring is spaced apart from the first annular lip by at least 0.1 inches.

13. The geophone of claim 12, further comprising a second pole cap disposed at and engaging a second end of the magnet, the second pole cap comprising:
a first end; and
a shoulder that is parallel to and spaced apart from the first end of the second pole cap by at least 0.1 inches; and
a second end that forms a cap that engages the second end of the magnet, the cap comprising a second annular lip that retains the magnet.

14. The geophone of claim 13, wherein the second spring is disposed parallel to and is spaced apart from the shoulder of the second pole cap by at least 0.1 inches.

15. The geophone of claim 13, wherein the annular ring is spaced apart from the second annular lip by at least 0.1 inches.

16. The geophone of claim 9, wherein the tubular case has an outside diameter of no more than 1.25 inches.

17. A geophone, comprising:
a tubular case having length of no more than 1.7 inches and outside diameter of no more than 1.25 inches, and disposed within the tubular case:
a magnet;
a first pole cap disposed at and engaging a first end of the magnet, the first pole cap comprising:
a first end; and
a shoulder that is parallel to and spaced apart from the first end of the first pole cap by at least 0.1 inches;
a second pole cap disposed at and engaging a second end of the magnet, the second pole cap comprising:
a first end; and
a shoulder that is parallel to and spaced apart from the first end of the second pole cap by at least 0.1 inches;
an electrical coil assembly disposed about the magnet, the first pole cap, and the second pole cap, wherein the electrical coil assembly is movable in an axial direction with respect to the magnet, the first pole cap, and the second pole cap, the electrical coil assembly comprising:
a first coil form;
a second coil form;
a first spring disposed between a first end of the first coil form and the first end of the first pole cap, wherein the first spring is disposed parallel to and is spaced apart from the shoulder of the first pole cap by at least 0.1 inches; and
a second spring disposed between a first end of the second coil form and the first end of the second pole cap, wherein the second spring is disposed parallel to and is spaced apart from the shoulder of the second pole cap by at least 0.1 inches;
wherein the first spring and the second spring are configured to produce a natural frequency in a range of 9 Hertz to 12.5 Hertz in oscillation of the electrical coil assembly about the magnet;
wherein the magnet, the first pole cap, the second pole cap, and the coil assembly are coaxially disposed within the tubular case, and the electrical coil assembly is configured to move in an axial direction with respect to the magnet in any orientation of the tubular case.

18. The geophone of claim 17, wherein the first coil form comprises a second end, and the second coil form comprises a second end; wherein the second end of the first coil form engages the second end of the second coil form to form an annular ring about the magnet.

19. The geophone of claim 18, wherein:
the first pole cap comprises a second end that forms a cap that engages the first end of the magnet, the cap comprising a first annular lip that retains the magnet; and
the annular ring about the magnet is spaced apart from the first annular lip by at least 0.1 inches.

20. The geophone of claim 19, wherein:
the second pole cap comprises a second end that forms a cap that engages the second end of the magnet, the cap comprising a second annular lip that retains the magnet; and
the annular ring about the magnet is spaced apart from the second annular lip by at least 0.1 inches.
